(19) United States
(12) Patent Application Publication
(10) Pub. No.: US 2021/0266285 A1
(43) Pub. Date: Aug. 26, 2021

(54) System And Method For Progressively Deeper Guided Communication

(71) Applicant: Charly, Inc., Toronto (CA)

(72) Inventor: Charles Messow, Toronto (CA)

(73) Assignee: Charly, Inc., Toronto, ON (CA)

(21) Appl. No.: 17/177,337

(22) Filed: Feb. 17, 2021

Related U.S. Application Data
(60) Provisional application No. 62/981,071, filed on Feb. 25, 2020.

(51) Int. Cl. H04L 12/58; G06F 16/9536; A63F 13/80; H04N 7/14

(52) U.S. Cl. CPC H04L 51/32; H04L 51/046; H04N 7/141; G06F 16/9536; A63F 13/80; H04L 51/16

(57) ABSTRACT

A system and a method for progressively deeper forms of communication between two previously unknown individuals in a predetermined time frame are disclosed herein. The method includes progressively exchanging texts, video messages and telephone numbers within a set time period. The method and system also includes playing compatibility games at different levels of the match flow relationship.

### CROSS REFERENCE TO RELATED APPLICATION

The Present application claims priority to U.S. Provisional Patent Application No. 62/981,071, filed on Feb. 25, 2020, which is hereby incorporated by reference in its entirety.

### STATEMENT REGARDING FEDERALLY SPONSORED RESEARCH OR DEVELOPMENT

Not Applicable

### BACKGROUND OF THE INVENTION

### Field of the Invention

The present invention generally relates to communications between two previously unknown individuals.

### Description of the Related Art

The general problems with dating apps or online dating are: 1) Wasted time; 2) Safety; and 3) Fake profiles (Misrepresentation of profile and personality).

More specific problems with dating apps or online dating are: 1) Stagnant conversations; 2) Unrevealing online interactions (texting only); 3) Limited ROI on time in apps; 4) Time spent on bad dates due to poor screening online; 5) Sharing personal information before establishing chemistry or a baseline of trust; 6) Taking the time to meet in person before establishing chemistry; and 7) Fake profiles targeting victims for abuse, deception, or fraud.

General definitions for terms utilized in the pertinent art are set forth below.

APP is a software application for a mobile phone such as a smart phone.

Application Programming Interface (API) is a collection of computer software code, usually a set of class definitions, that can perform a set of related complex tasks, but has a limited set of controls that may be manipulated by other software-code entities. The set of controls is deliberately limited for the sake of clarity and ease of use, so that programmers do not have to work with the detail contained within the given API itself.

BLUETOOTH technology is a standard short range radio link that operates in the unlicensed 2.4 gigaHertz band.

BLUETOOTH LOW ENERGY (aka “BLE” or “BLUETOOTH LE”) is a communication format from the Bluetooth Special Interest Group which uses the 2.4 gigaHertz band of BLUETOOTH technology but with a simpler modulation system that supports data pockets ranging from 8 to 27 octets, which are transferred at 1 Mbps.

FTP or File Transfer Protocol is a protocol for moving files over the Internet from one computer to another.

Hypertext Transfer Protocol (“HTTP”) is a set of conventions for controlling the transfer of information via the Internet from a web server computer to a client computer, and also from a client computer to a web server, and Hypertext Transfer Protocol Secure (“HTTPS”) is a communications protocol for secure communication via a network from a web server computer to a client computer, and also from a client computer to a web server by at a minimum verifying the authenticity of a web site.

Internet is the worldwide, decentralized totality of server computers and data-transmission paths which can supply information to a connected and browser-equipped client computer, and can receive and forward information entered from the client computer.

Media Access Control (MAC) Address is a unique identifier assigned to the network interface by the manufacturer.

SSID (Service Set Identifier) is a 1 to 32 byte string that uniquely names a wireless local area network.

Transfer Control Protocol/Internet Protocol (“TCP/IP”) is a protocol for moving files over the Internet.

URL or Uniform Resource Locator is an address on the World Wide Web.

User Interface or UI is the junction between a user and a computer program. An interface is a set of commands or menus through which a user communicates with a program. A command driven interface is one in which the user enter commands. A menu-driven interface is one in which the user selects command choices from various menus displayed on the screen.

Web-Browser is a complex software program, resident in a client computer, that is capable of loading and displaying text and images and exhibiting behaviors as encoded in HTML (HyperText Markup Language) from the Internet, and also from the client computer's memory. Major browsers include MICROSOFT INTERNET EXPLORER, NETSCAPE, APPLE SAFARI, MOZILLA FIREFOX, and OPERA.

Web-Server is a computer able to simultaneously manage many Internet information-exchange processes at the same time. Normally, server computers are more powerful than client computers, and are administratively and/or geographically centralized. An interactive-form information-collection process generally is controlled from a server computer, to which the sponsor of the process has access.

Wireless Application Protocol (“WAP”) is an open, global specification that empowers users with mobile wireless communication devices (such as mobile phones) to easily access data and to interact with Websites over the Internet through such mobile wireless communication device. WAP works with most wireless communication networks such as CDPD, CDMA, GSM, PDC, PHS, TDMA, FLEX, reflex, iDEN, TETRA, DECT, DataTAC, Mobitex and GRPS. WAP can be built on most operating systems including PalmOS, WINDOWS, CE, FLEXOS, OS/9, JavaOS and others.

Wireless AP (access point) is a node on the wireless local area network (WLAN) that allows wireless devices to connect to a wired network using Wi-Fi, or related standards.

There is a need for a better way of two unknown individuals communicating with each other to form a social connection.

### BRIEF SUMMARY OF THE INVENTION

The purpose of the invention is to allow two people to mutually vet each other and quickly build rapport online before deciding to meet in person. The purpose of the invention is to enable two strangers who meet online to safely engage in deeper and more meaningful forms of communication before sharing personal details or before meeting in person.

One aspect of the present invention is a method for progressively deeper forms of communication between two previously unknown individuals in a predetermined time frame. The method includes generating a new message thread between two previously unknown individuals. The method also includes playing a first compatibility game between the two previously unknown individuals. The method also includes exchanging a plurality of text messages between the two previously unknown individuals. The method also includes agreeing between the two previously unknown individuals to proceed to a level two. The method also includes playing a second compatibility game between the two previously unknown individuals. The method also includes exchanging a plurality of voice messages between the two previously unknown individuals. The method also includes agreeing between the two previously unknown individuals to proceed to a level three. The method also includes playing a third compatibility game between the two previously unknown individuals. The method also includes exchanging at least one video message between the two previously unknown individuals. The method also includes agreeing between the two previously unknown individuals to proceed to a final level of exchanging phone numbers within seven days of the new message thread.

Yet another aspect of the present invention is a non-transitory computer-readable medium that stores a program that causes a processor to perform functions to progressively form deeper communication between two previously unknown individuals in a predetermined time frame by executing the following steps. The first step is generating a new message thread between two previously unknown individuals. Next, playing a first compatibility game between the two previously unknown individuals. Next, exchanging a plurality of text messages between the two previously unknown individuals. Next, agreeing between the two previously unknown individuals to proceed to a level two. Next, playing a second compatibility game between the two previously unknown individuals. Next, exchanging a plurality of voice messages between the two previously unknown individuals. Next, agreeing between the two previously unknown individuals to proceed to a level three. Next, playing a third compatibility game between the two previously unknown individuals. Next, exchanging at least one video message between the two previously unknown individuals. Next, agreeing between the two previously unknown individuals to proceed to a final level of exchanging phone numbers within seven days of the mew message thread.

Yet another aspect of the present invention is a mobile application for progressively deeper forms of communication between two previously unknown individuals in a predetermined time frame. The mobile application is configured to process a new message thread between two previously unknown individuals. The mobile application is also configured to enable the playing of a plurality of a compatibility games between the two previously unknown individuals. The mobile application is also configured to enable the exchange of a plurality of text messages between the two previously unknown individuals. The mobile application is also configured to enable the agreement between the two previously unknown individuals to proceed to higher levels of communications. The mobile application is also configured to enable the exchange of a plurality of voice messages between the two previously unknown individuals. The mobile application is also configured to enable the exchange of at least one video message between the two previously unknown individuals. The mobile application is also configured to enable the agreement between the two previously unknown individuals to proceed to a final level of exchanging phone numbers within seven days of the mew message thread.

Yet another aspect of the present invention is a server for progressively deeper forms of communication between two previously unknown individuals in a predetermined time frame. The server is configured to process a new message thread between two previously unknown individuals. The server is also configured to enable the playing of a plurality of a compatibility games between the two previously unknown individuals. The server is also configured to enable the exchange of a plurality of text messages between the two previously unknown individuals. The server is also configured to enable the agreement between the two previously unknown individuals to proceed to higher levels of communications. The server is also configured to enable the exchange of a plurality of voice messages between the two previously unknown individuals. The server is also configured to enable the exchange of at least one video message between the two previously unknown individuals. The server is also configured to enable the agreement between the two previously unknown individuals to proceed to a final level of exchanging phone numbers within seven days of the mew message thread.

Yet another aspect of the present invention is a non-transitory computer-readable medium that stores a program that causes a processor to perform functions to progressively form deeper communication between two previously unknown individuals in a predetermined time frame. The non-transitory computer-readable medium is configured to process a new message thread between two previously unknown individuals. The non-transitory computer-readable medium is also configured to enable the playing of a plurality of a compatibility games between the two previously unknown individuals. The non-transitory computer-readable medium is also configured to enable the exchange of a plurality of text messages between the two previously unknown individuals. The non-transitory computer-readable medium is also configured to enable the agreement between the two previously unknown individuals to proceed to higher levels of communications. The non-transitory computer-readable medium is also configured to enable the exchange of a plurality of voice messages between the two previously unknown individuals. The non-transitory computer-readable medium is also configured to enable the exchange of at least one video message between the two previously unknown individuals. The non-transitory computer-readable medium is also configured to enable the agreement between the two previously unknown individuals to proceed to a final level of exchanging phone numbers within seven days of the mew message thread.

Yet another aspect of the present invention is a method for progressively deeper forms of communication between two previously unknown individuals in a predetermined time frame. The method includes requesting at a mobile application a state from a server including functionality enablement flags when the user signals intent to communicate with a match. The method also includes accepting at a sender's mobile application a message text and making an API call to the server. The method also includes storing at the server the message and notifying the recipient using both a realtime Pubnub message and using a mobile-native push notification. The method also includes providing a plurality of games containing specific business logic to assess mutual compatibility. The method also includes accepting at the sender's mobile application a voice message using a built-in microphone, wherein the voice message is transcoded to a normalized bitrate on the mobile application, and the transcoded voice message is transmitted to the server where the server stores the audio file on S3 and then notifies the recipient in the same way as for messages. The method also includes accepting at the sender's mobile application a video using a built-in video camera, wherein the video file is transcoded to a normalized bitrate on the mobile application, and the transcoded video file is transmitted to the server where the server stores the video file on S3 and then notifies the recipient in the same way as for messages. The method also includes storing at the server the acceptance state of the other party and once accepted the server transmits the previously saved phone number to the other party.

The compatibility game is preferably a multiple choice questions game or an open form answers game.

The predetermined time frame is preferably from three days to seven days.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a flow chart of a method for progressively deeper forms of communication between two previously unknown individuals in a predetermined time frame.

FIG. 2 is a block diagram of a system for progressively deeper forms of communication between two previously unknown individuals in a predetermined time frame.

FIG. 3 is a flow chart of a method for progressively deeper forms of communication between two previously unknown individuals in a predetermined time frame.

FIG. 4 is a flow chart of a method for progressively deeper forms of communication between two previously unknown individuals in a predetermined time frame.

FIG. 5 is an illustration of two previously unknown individuals engaging in communications.

FIG. 6 is a block diagram of a server for progressively deeper forms of communication between two previously unknown individuals in a predetermined time frame.

FIG. 7 is a block diagram of a system for progressively deeper forms of communication between two previously unknown individuals in a predetermined time frame.

FIG. 8 is a flow chart of a method for progressively deeper forms of communication between two previously unknown individuals in a predetermined time frame.

FIG. 9 is a communications sequence diagram for progressively deeper forms of communication between two previously unknown individuals in a predetermined time frame.

FIG. 9A is a continuation of the communications sequence diagram of FIG. 9.

FIG. 9B is a continuation of the communications sequence diagram of FIG. 9A.

FIG. 9C is a continuation of the communications sequence diagram of FIG. 9B.

FIG. 9D is a continuation of the communications sequence diagram of FIG. 9C.

FIG. 9E is a continuation of the communications sequence diagram of FIG. 9D.

FIG. 9F is a continuation of the communications sequence diagram of FIG. 9E.

FIG. 9G is a continuation of the communications sequence diagram of FIG. 9F.

FIG. 9H is a continuation of the communications sequence diagram of FIG. 9G.

FIG. 9I is a continuation of the communications sequence diagram of FIG. 9H.

FIG. 9J is a continuation of the communications sequence diagram of FIG. 9I.

FIG. 9K is a continuation of the communications sequence diagram of FIG. 9J.

FIG. 9L is a continuation of the communications sequence diagram of FIG. 9K.

FIG. 9M is a continuation of the communications sequence diagram of FIG. 9L.

FIG. 9N is a continuation of the communications sequence diagram of FIG. 9M.

FIG. 9O is a continuation of the communications sequence diagram of FIG. 9N.

FIG. 9P is a continuation of the communications sequence diagram of FIG. 9O.

FIG. 9Q is a continuation of the communications sequence diagram of FIG. 9P.

FIG. 9R is a continuation of the communications sequence diagram of FIG. 9Q.

FIG. 9S is a continuation of the communications sequence diagram of FIG. 9R.

FIG. 9T is a continuation of the communications sequence diagram of FIG. 9S.

FIG. 9U is a continuation of the communications sequence diagram of FIG. 9T.

FIG. 10 is an illustration of a screenshot of an initial matching page.

FIG. 11 is an illustration of a screenshot of a compatibility game.

FIG. 11A is an enlarged view of a level 1 compatibility game of FIG. 11.

FIG. 12 is an illustration of a screenshot of the start of texting between two previously unknown individuals after a compatibility game match.

FIG. 13 is an illustration of a screenshot after texting between two previously unknown individuals to move to the next level.

FIG. 14 is an enlarged view of FIG. 13 to show level 2.

### DETAILED DESCRIPTION OF THE INVENTION

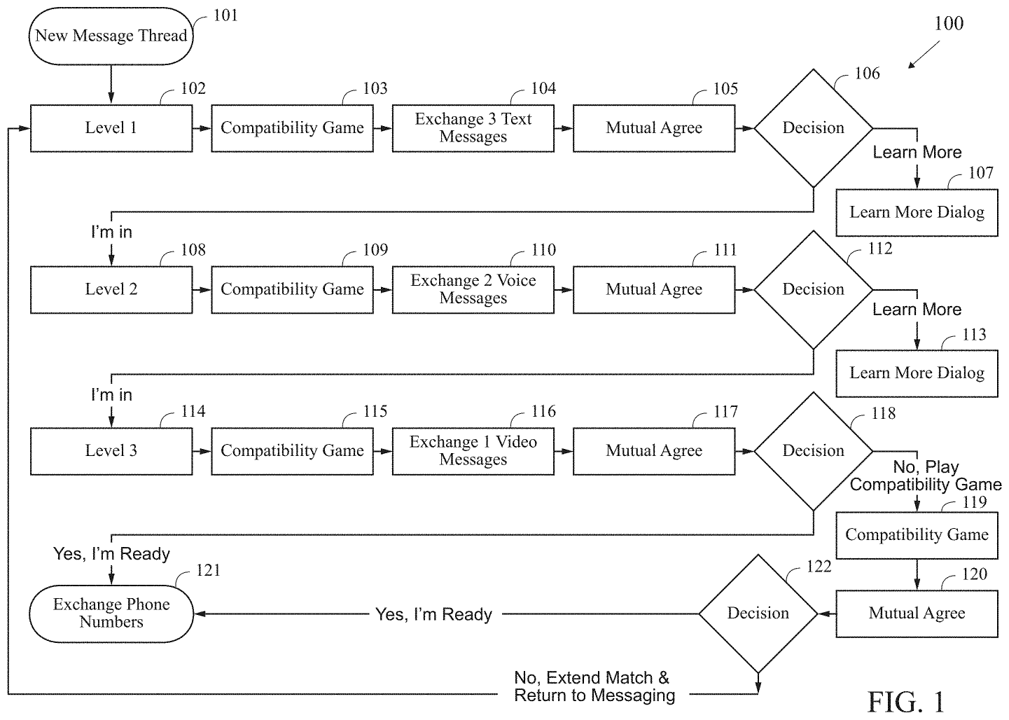

FIG. 1 is a flow chart of a preferred method for progressively deeper forms of communication between two previously unknown individuals in a predetermined time frame. At block 101, a new message thread is generated between two previously unknown individuals. At block 102, the two previously unknown individuals begin level 1. At block 103, a first compatibility game is played between the two previously unknown individuals. At block 104, text messages are exchanged between the two previously unknown individuals. At block 105, the two previously unknown individuals agree to proceed. At decision 106, the two previously unknown individuals decide whether to learn more through dialog at block 107 or proceed to level 2 at block 108. At block 109, a second compatibility game is played between the two previously unknown individuals. At block 110, voice messages are exchanged between the two previously unknown individuals. At block 111, the two previously unknown individuals agree to proceed. At decision 112, the two previously unknown individuals decide whether to learn more dialog at block 113, or proceed to level 3 at block 114. At block 115, a third compatibility game is played between the two previously unknown individuals. At block 116, at least one video message is exchanged between the two previously unknown individuals. At block 117, the two previously unknown individuals agree to proceed. At decision 118, the two previously unknown individuals decide whether to play another compatibility game at block 119, the n agree at block 120 to decide to proceed or extend the match an return to messaging, or at block 121 exchange phone numbers within seven days of the new message thread.

The method for progressively deeper forms of communication between two previously unknown individuals in a predetermined time frame preferably has a match expiration time; 2) multiple points (mutual agree) at which both users must agree to proceed or remove the match; 3) multiple-choice questions for users to establish chemistry (may need to remove); and 4) voice and video messages for users to establish chemistry and verify that their match hasn't misrepresented their identity.

The present invention is a process that allows two people to engage in three levels of communication that progresses from text to voice and then to video messaging within seven days and requiring both parties to mutually agree before proceeding to the next level. Once completing all levels, both parties must mutually agree to complete the process for phone numbers to be exchanged. The match (connection) times out in seven days if the process is not complete.

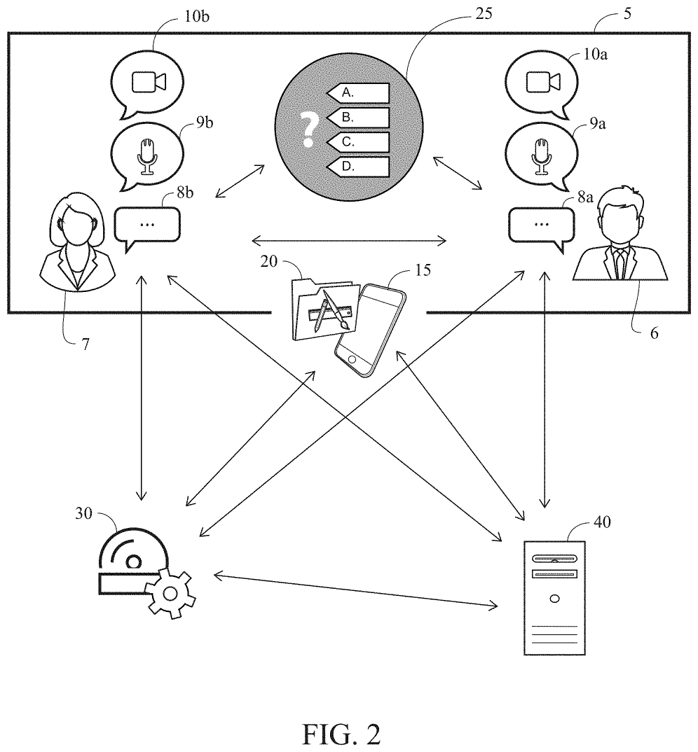

As shown in FIG. 2, two previously unknown individuals 6 and 7 engage in a relationship flow interaction 5 using a mobile app 20 on a mobile phone 15. The mobile app 20 interacts over a network with a server 40 and CRM 30. The individuals 6 and 7 send texts 8a and 8b to each other. The individuals 6 and 7 can also play compatibility games 25. At a next level the individuals 6 and 7 exchange voice messages 9a and 9b. At a next level, the individuals 6 and 7 exchange video messages 10a and 10b.

A method of the present invention includes the following steps: Users match—New message thread created. Compatibility game—Answer multiple choice question. Level 1 (text messaging)—Exchange 3 text messages (6 total). Mutual agree—Decision to proceed or remove match. Compatibility game—Answer multiple choice question. Level 2 (voice messaging)—Exchange 2 voice messages (4 total). Mutual agree—Decision to proceed or remove match. Compatibility game—Answer multiple choice question. Level 3 (video messaging)—Exchange 1 video message (2 total). Mutual agree—Decision to release phone numbers or remove match.

The specific interactions of the Cove Flow include 1) coordination: when the user signals intent to communicate with a match, the mobile application requests state from the server including functionality enablement flags. 2) message: the sender's mobile application accepts the message text and makes an API call to the server. Then the server (if accepted) will store the message and notify the recipient using both a realtime Pubnub message and using a mobile-native push notification. 3) games: these contain specific business logic to assess mutual compatibility 4) voice message: the sender's mobile application accepts a voice message using the devices built-in microphone. The voice message is transcoded to a normalized bitrate on the mobile application, and then transmitted to the server where the server (if accepted) stores the audio file on S3 and then notifies the recipient in the same way as for messages, 5) video message: is facilitated in the same way as voice message but a video file and video camera is also used, 6) phone number exchange: once initiated, the server stores the acceptance state of the other party and once accepted the server transmits the previously saved phone number to the other party.

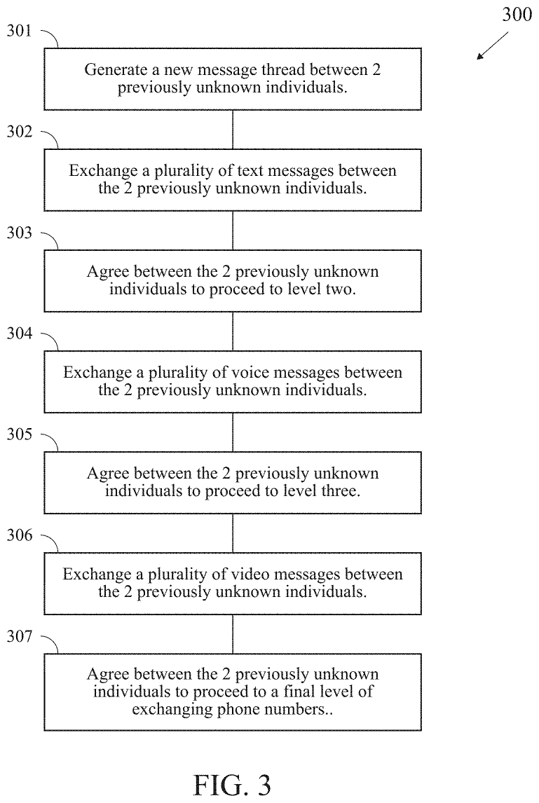

A method 300 for progressively deeper forms of communication between two previously unknown individuals in a predetermined time frame is shown in FIG. 3. At block 301, a new message thread is generated between two previously unknown individuals. At block 302, text messages are exchanged between the two previously unknown individuals. At block 303, the two previously unknown individuals agree to proceed to a level two. At block 304, voice messages are exchanged between the two previously unknown individuals. At block 305, the two previously unknown individuals agree to proceed to a level three. At block 306, video messages are exchanged between the two previously unknown individuals. At block 307, the two previously unknown individuals agree to proceed to a final level of exchanging phone numbers within seven days of the new message thread.

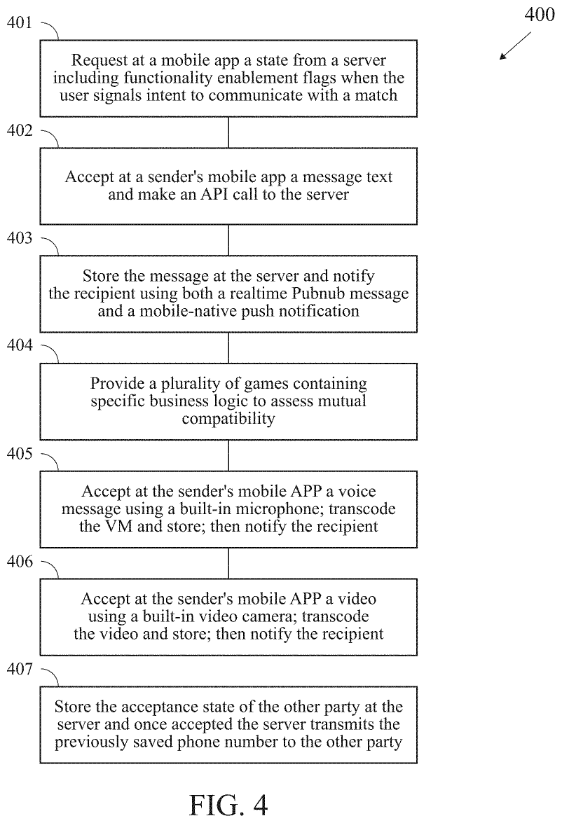

A method for progressively deeper forms of communication between two previously unknown individuals in a predetermined time frame is shown in FIG. 4. At block 401, at a mobile application, a state is requested from a server including functionality enablement flags when the user signals intent to communicate with a match. At block 402, at a sender's mobile application, a message text is accepted and an API call is made to the server. At block 403, at the server, the message is stored and the recipient of the message is notified using both a realtime Pubnub message and using a mobile-native push notification. At block 404, games containing specific business logic to assess mutual compatibility are provided to the mobile apps on the sender's phone and the recipient's phone. At block 405, at the sender's mobile application, a voice message is accepted using a built-in microphone, wherein the voice message is transcoded to a normalized bitrate on the mobile application, and the transcoded voice message is transmitted to the server where the server stores the audio file on S3 and then notifies the recipient in the same way as for messages. At block 406, at the sender's mobile application, a video is accepted using a built-in video camera, wherein the video file is transcoded to a normalized bitrate on the mobile application, and the transcoded video file is transmitted to the server where the server stores the video file on S3 and then notifies the recipient in the same way as for messages. At block 407, at the server, the acceptance state of the other party is stored, and once accepted the server transmits the previously saved phone number to the other party.

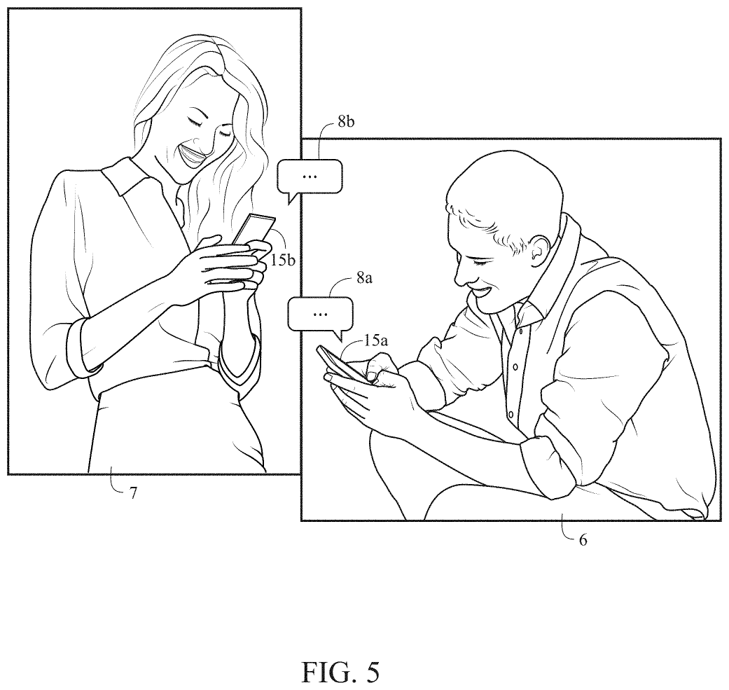

As shown in FIG. 5, two previously unknown individuals 6 and 7 engage in progressively deeper forms of communication in a predetermined time frame by exchanging texts 8a and 8b over phones 15a and 15b.

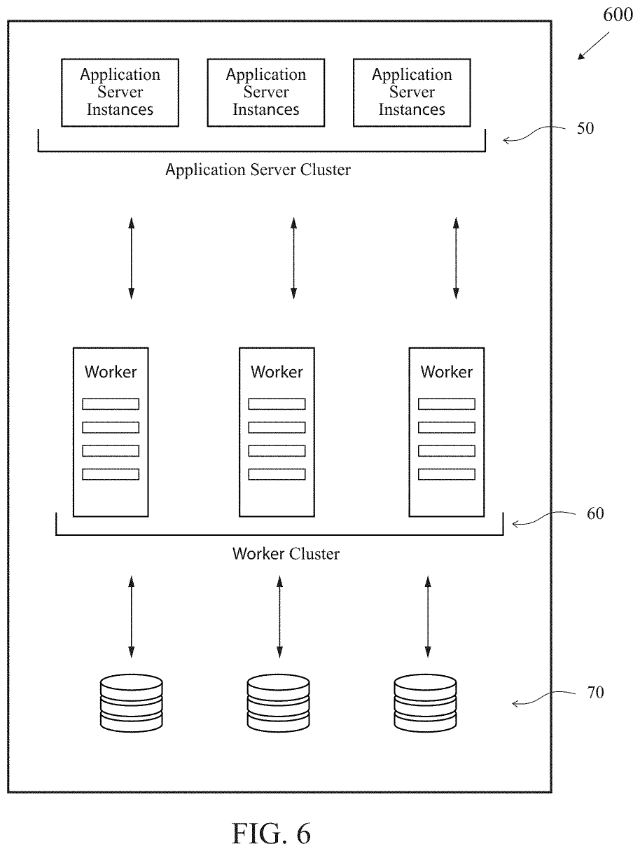

As shown in FIG. 6, the server 600 is preferably composed of three parts: 1) the stateless application server cluster 50; 2) the stateless worker tier cluster 60; and 3) various databases and services 70. The stateless application server cluster 50 and the stateless worker tier cluster 60 contain the business logic described above and the various databases and services 70 contain the state of users, matches, and other information. The business logic is preferably written in Javascript and running on Node.js using AWS service “Elastic Beanstalk.” The queuing service in use is preferably AWS SQS. The primary database is preferably MongoDB. An additional database, Redis, is preferably used for distributed locking and time-based caches. AWS service S3 is preferably used as the data store for large files such as voice and video messages. For faster delivery of voice and video messages, S3 is fronted by Amazon CloudFront. Other third-party services of note in use include 1) Pubnub: facilitates realtime conversation-centric communication from the server to the mobile apps, and 2) iOS and Android push notification services: these facilitate near-real-time mobile push notification functionality.

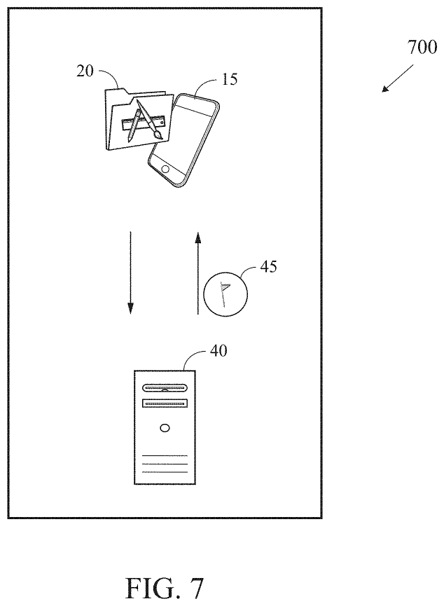

As shown in FIG. 7, the present invention preferably follows standard mobile application architecture and is comprised of two parts: 1) a mobile application 20 that runs on the end-users' smartphone (iOS and Android) 15; and 2) a backend API server 40. The mobile application 20 facilitates the user-interaction based on API calls to the backend server 40. The backend server is aware of the state of the relationship (see FIG. 1) between matched users and governs and facilitates the interactions (text, voice, video, phone number exchange) based on that state. Specifically, each state in the relationship flow has particular allowed interactions. When a user using the application desires to interact with a match, the allowed interactions are transmitted from the server to the application using “enablement flags 45.” When a successful interaction occurs, the server computes the next state if applicable and corresponding notifications and API responses are sent to ensure mutual awareness and engagement.

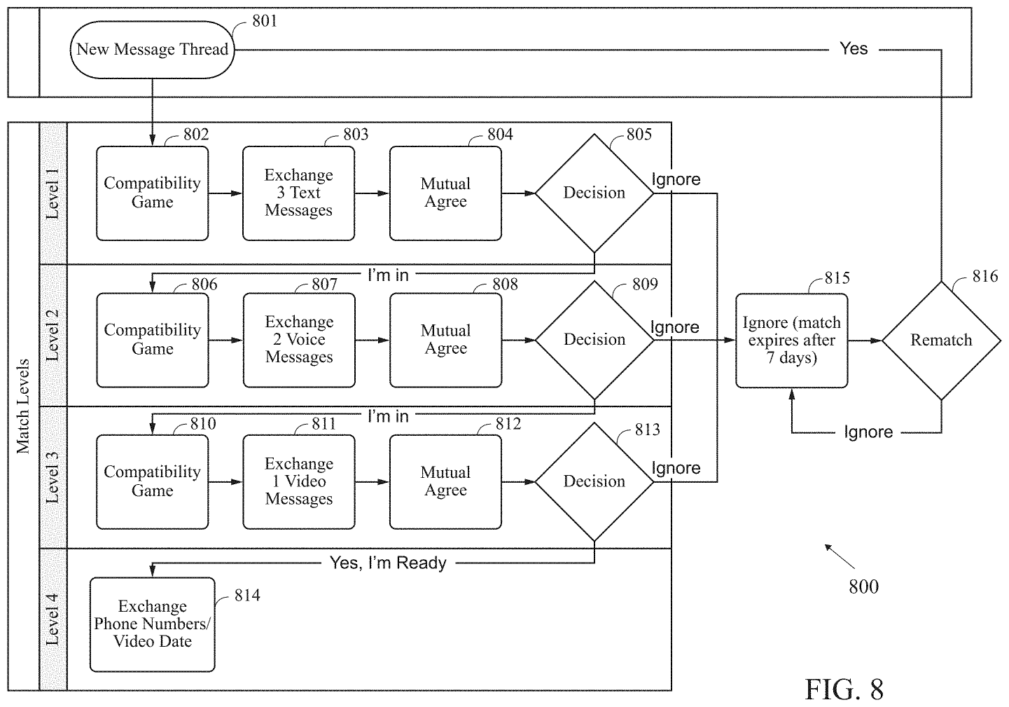

FIG. 8 is a flow chart of an alternative method 800 for progressively deeper forms of communication between two previously unknown individuals in a predetermined time frame. At block 801, a new message thread is generated between two previously unknown individuals. At block 802, a first compatibility game is played between the two previously unknown individuals. At block 803, text messages are exchanged between the two previously unknown individuals. At block 804, the two previously unknown individuals agree to proceed. At decision 805, the two previously unknown individuals decide whether to ignore the match or proceed to level 2 at block 806 with a second compatibility game. At block 807, voice messages are exchanged between the two previously unknown individuals. At block 808, the two previously unknown individuals agree to proceed. At decision 809, the two previously unknown individuals decide whether to ignore the match at block 815, or proceed to level 3. At block 810, a third compatibility game is played between the two previously unknown individuals. At block 811, at least one video message is exchanged between the two previously unknown individuals. At block 812, the two previously unknown individuals agree to proceed. At decision 813, the two previously unknown individuals decide whether to ignore the match at block 815, or at block 814 exchange phone numbers within seven days of the new message thread. If the match is ignored at block 15, then a rematch is set at block 816.

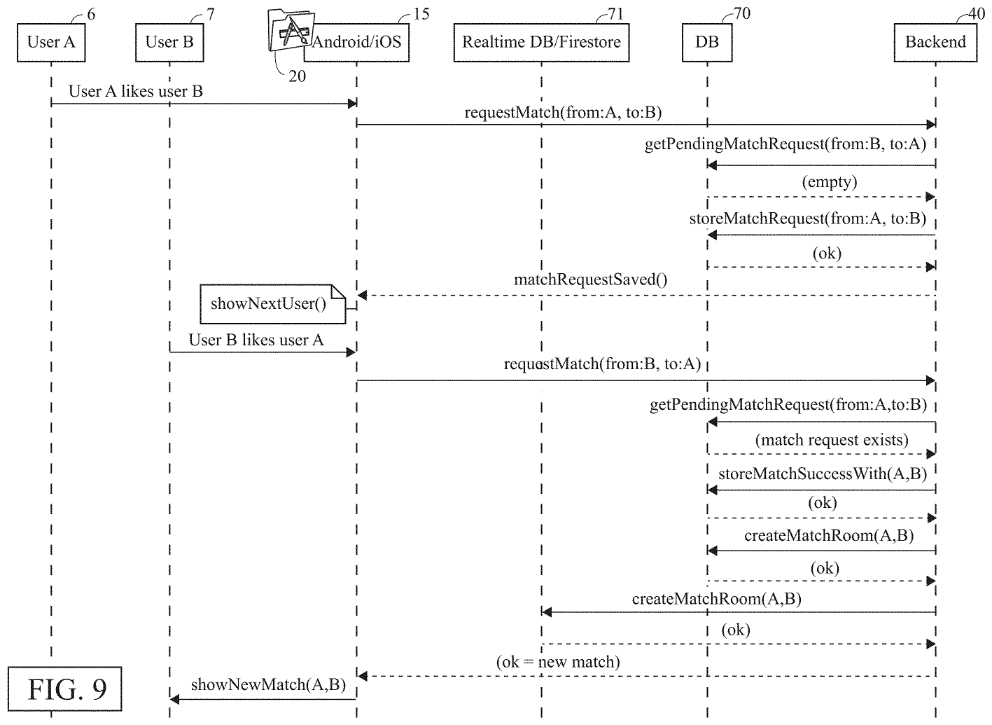

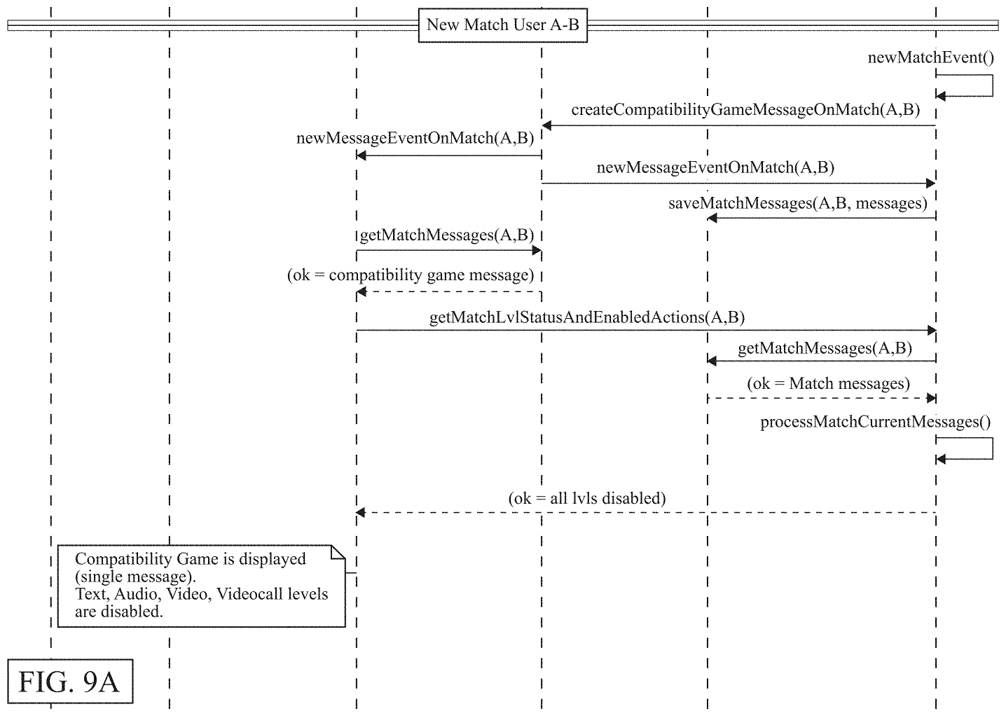

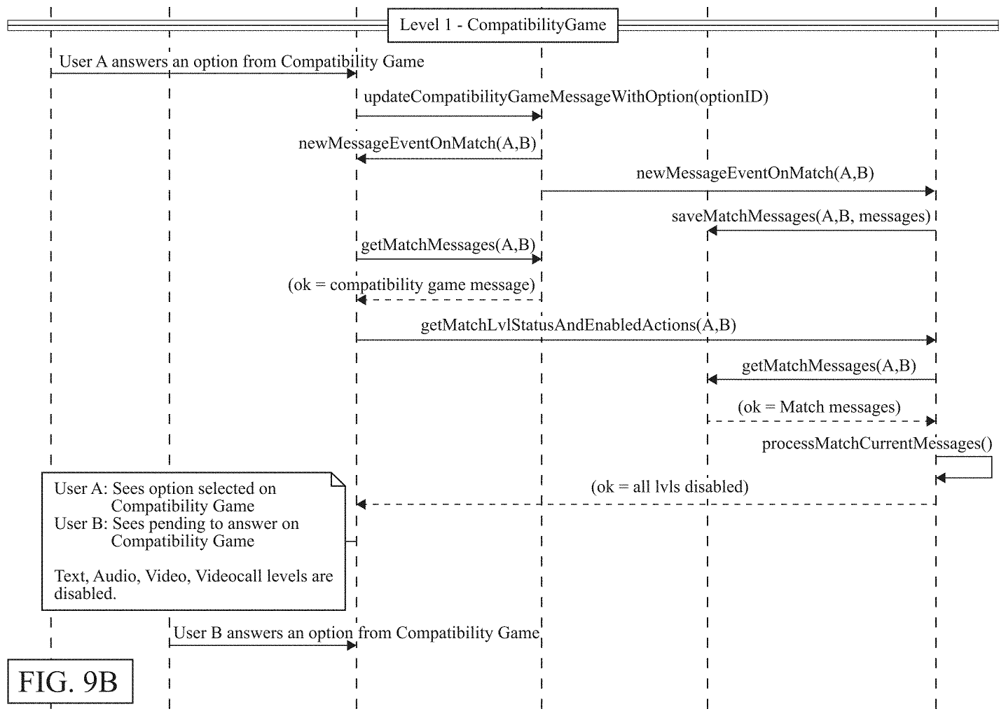

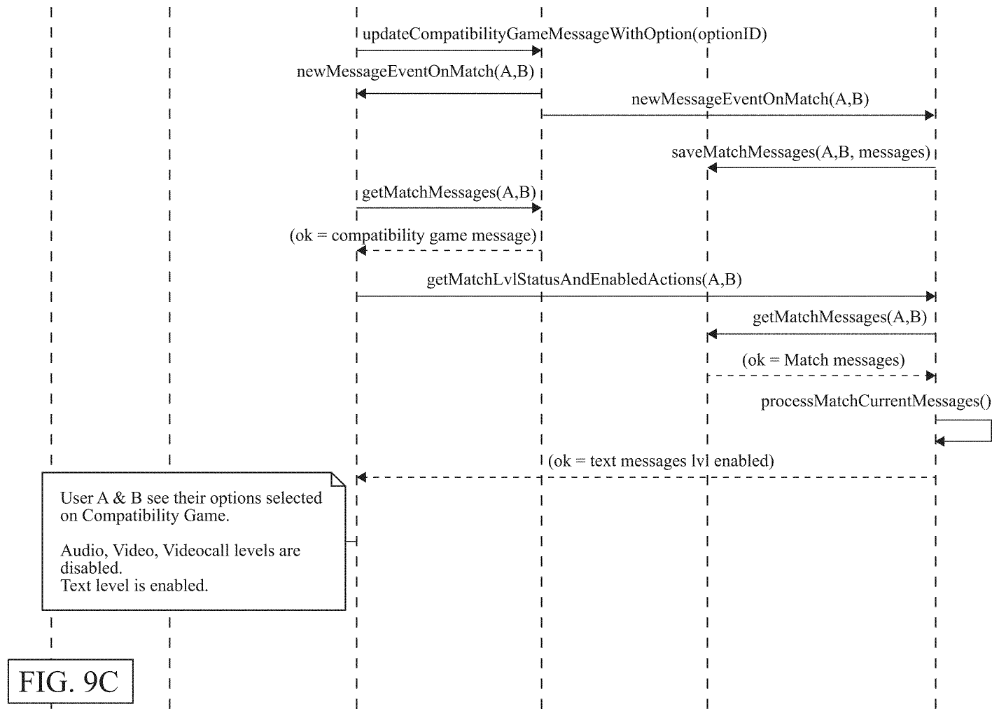

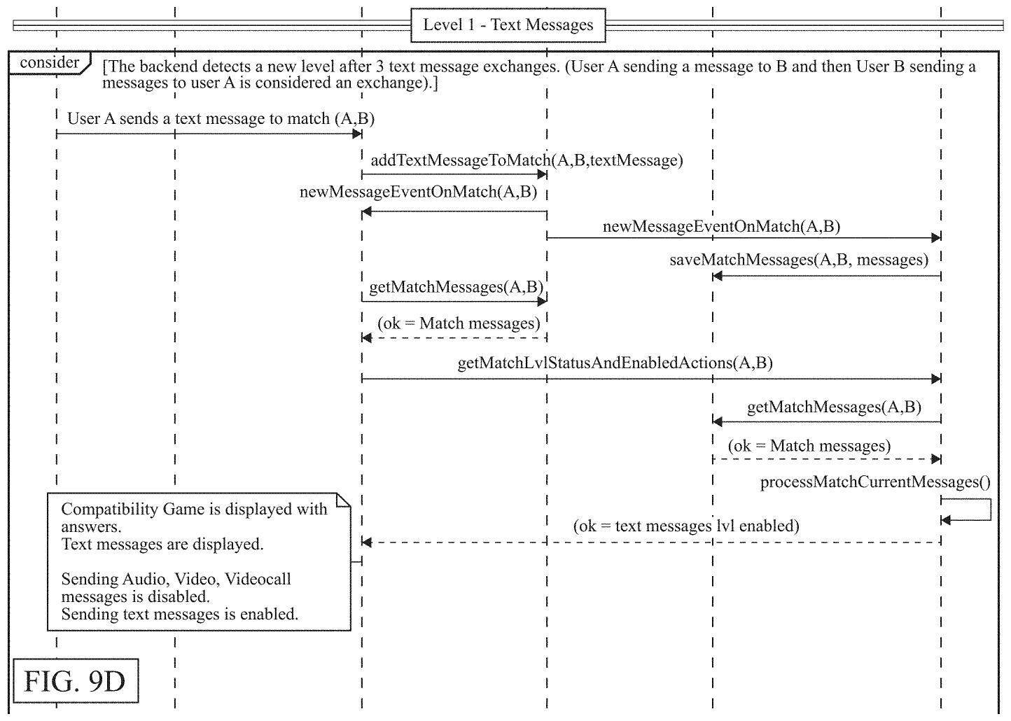

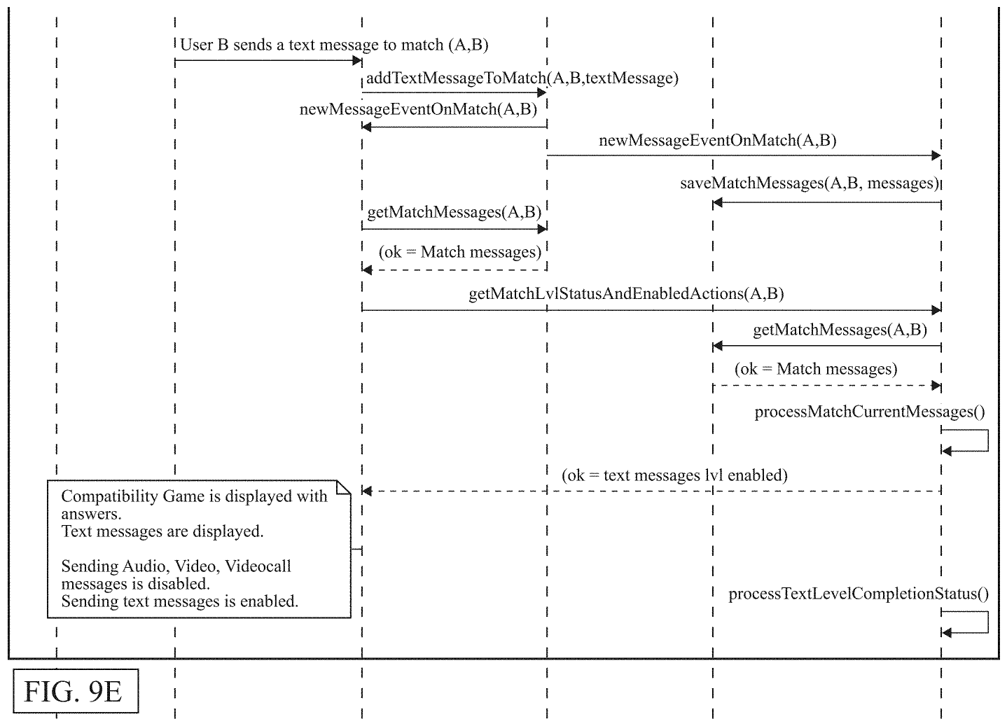

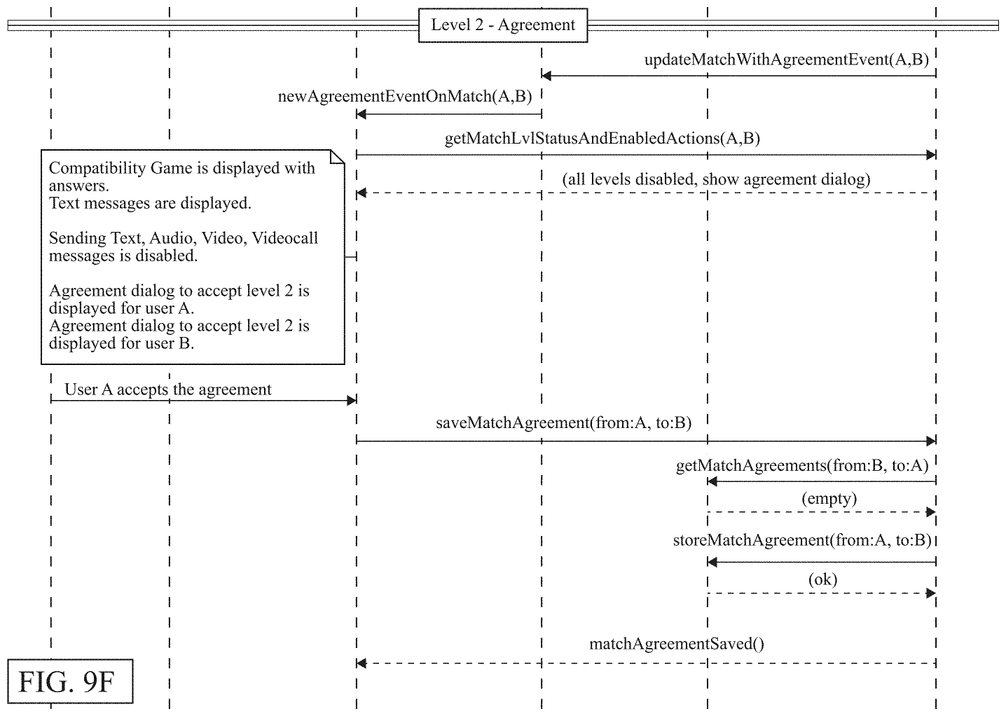

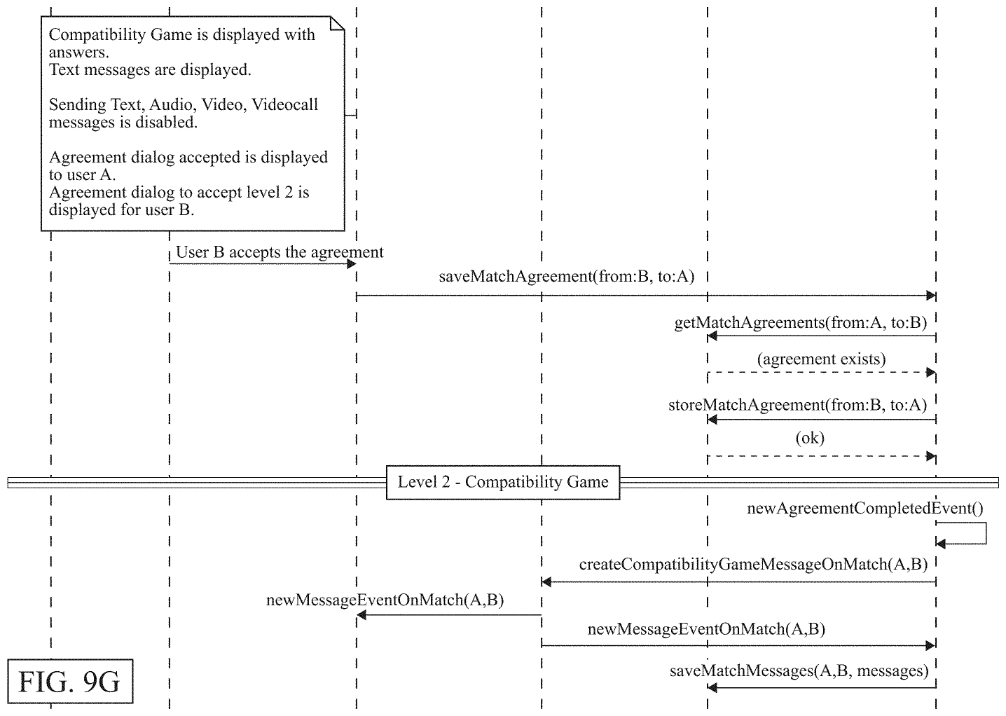

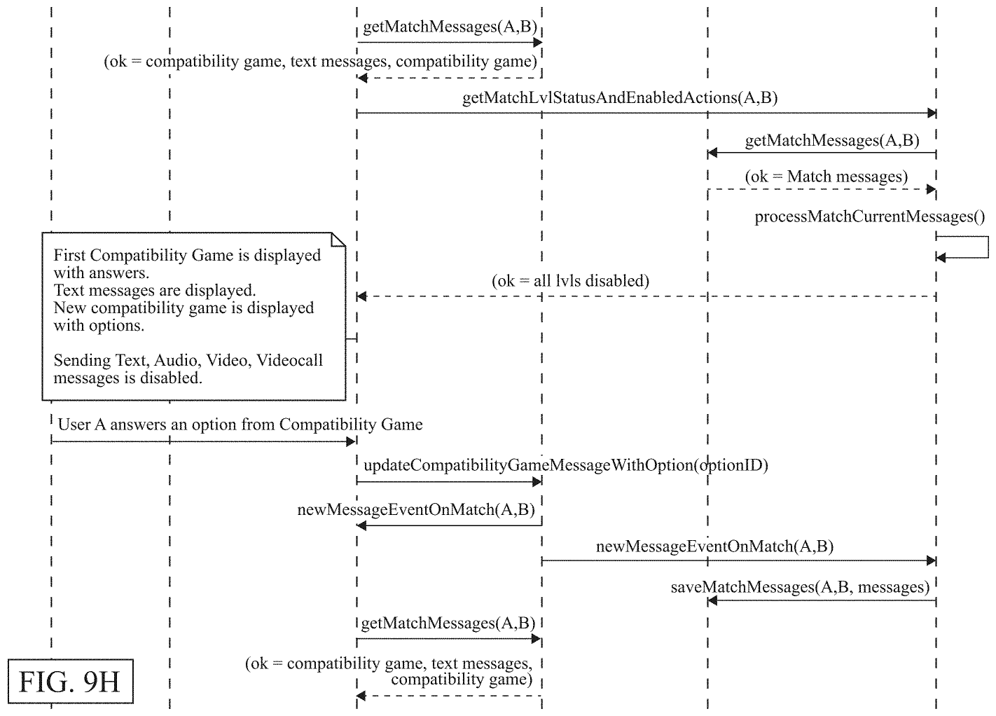

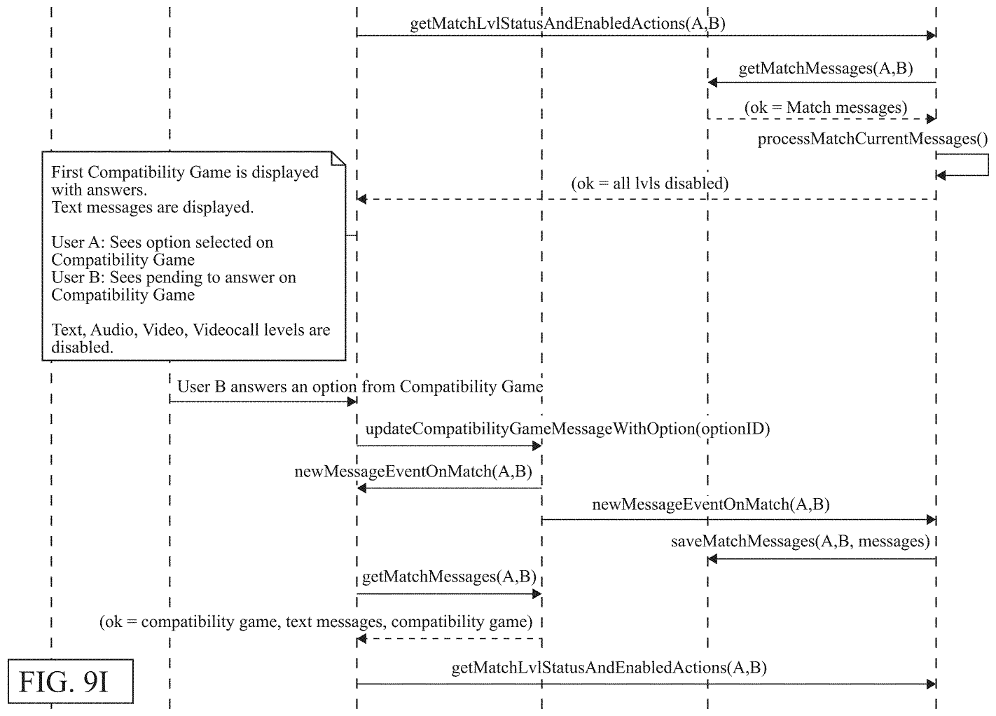

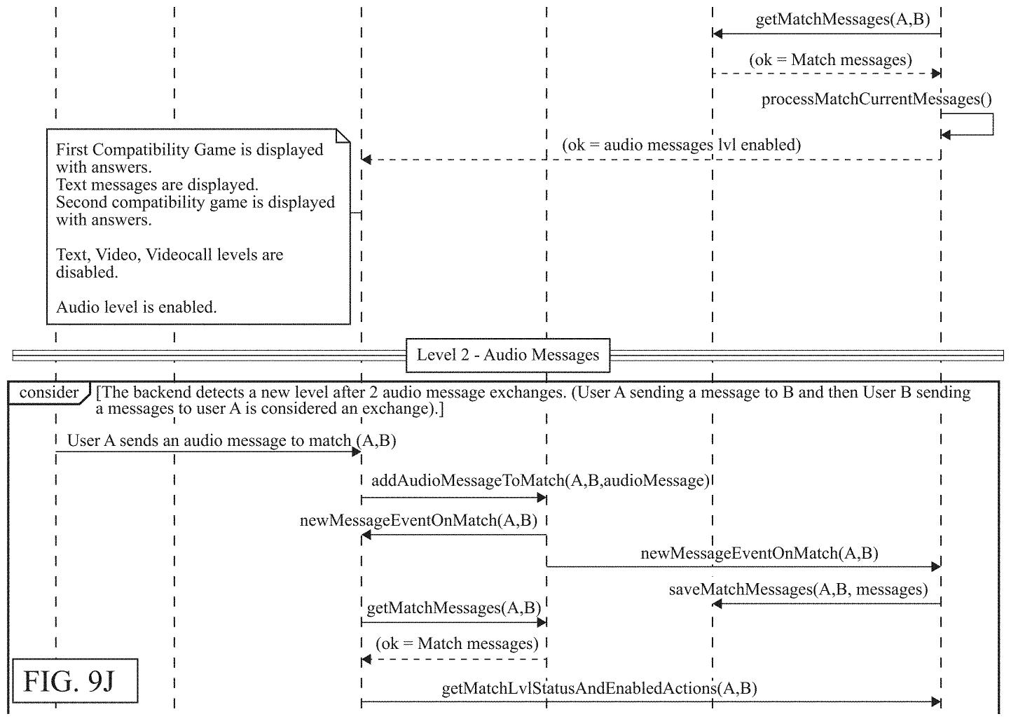

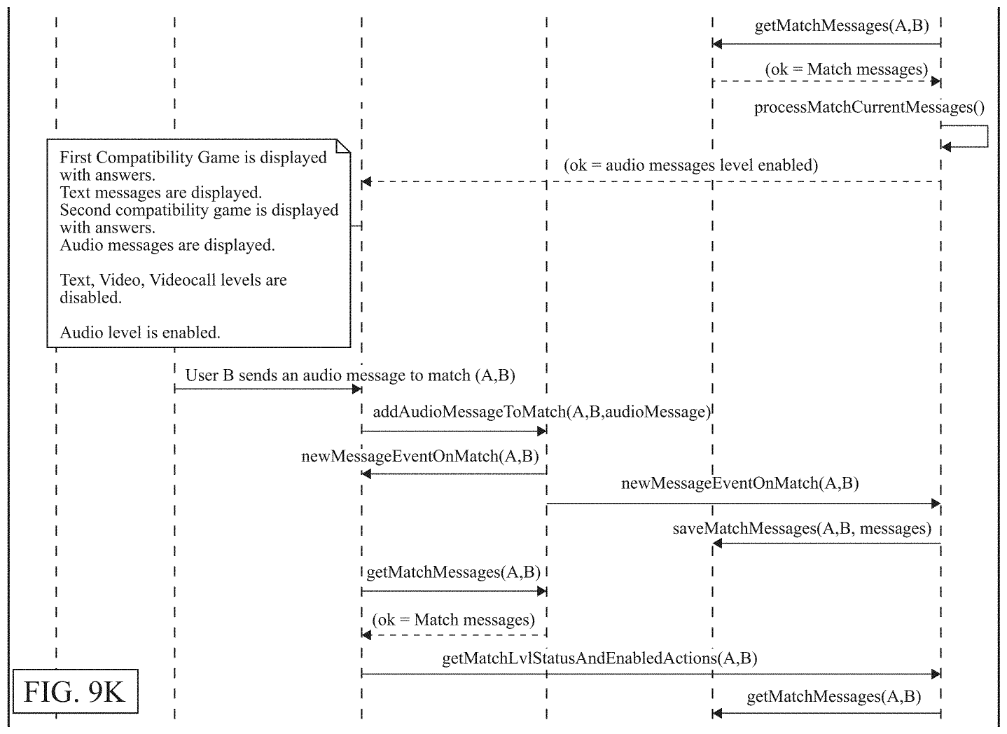

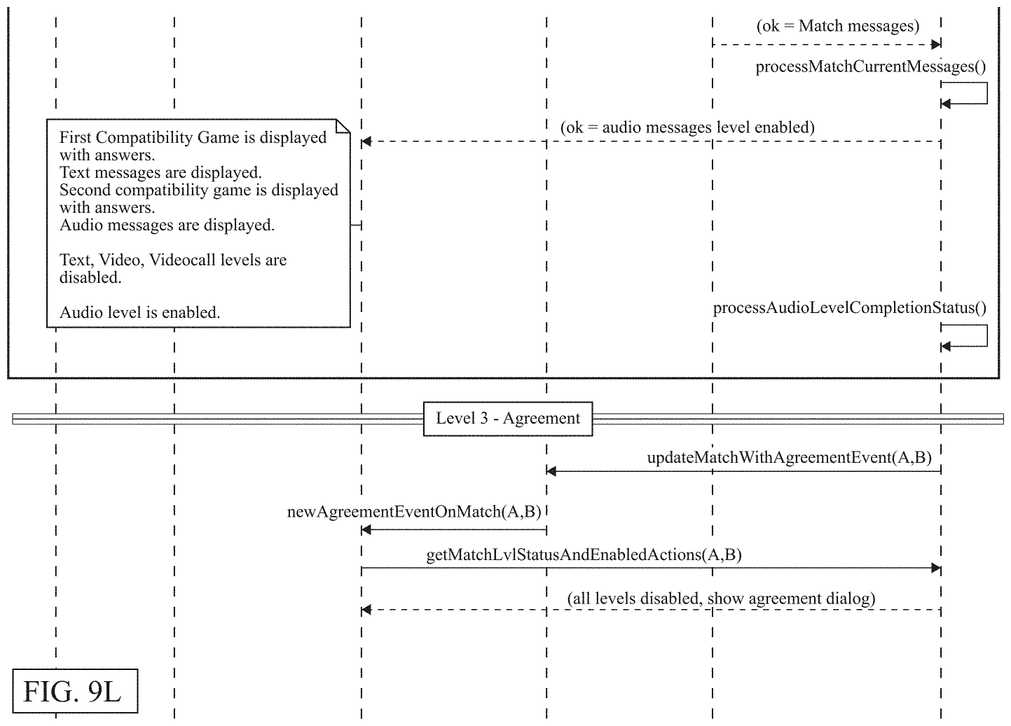

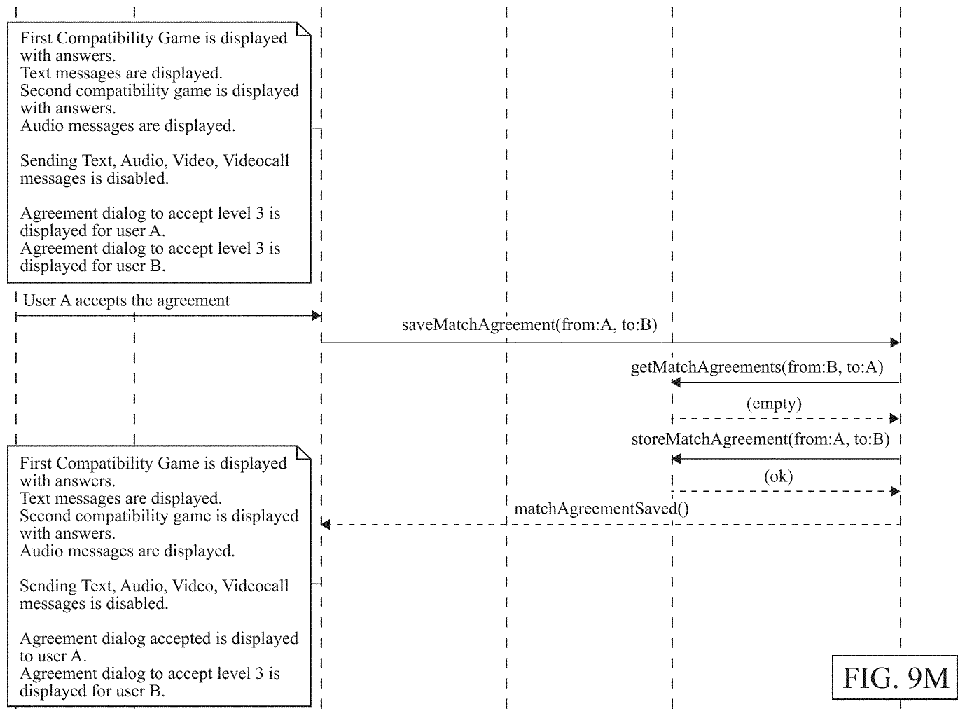

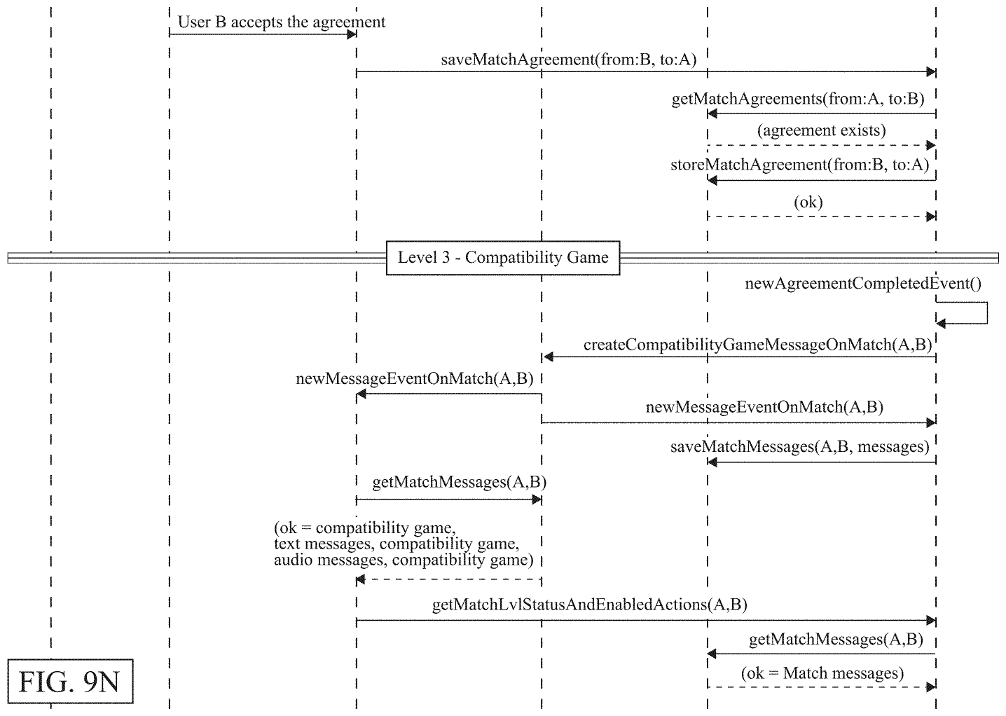

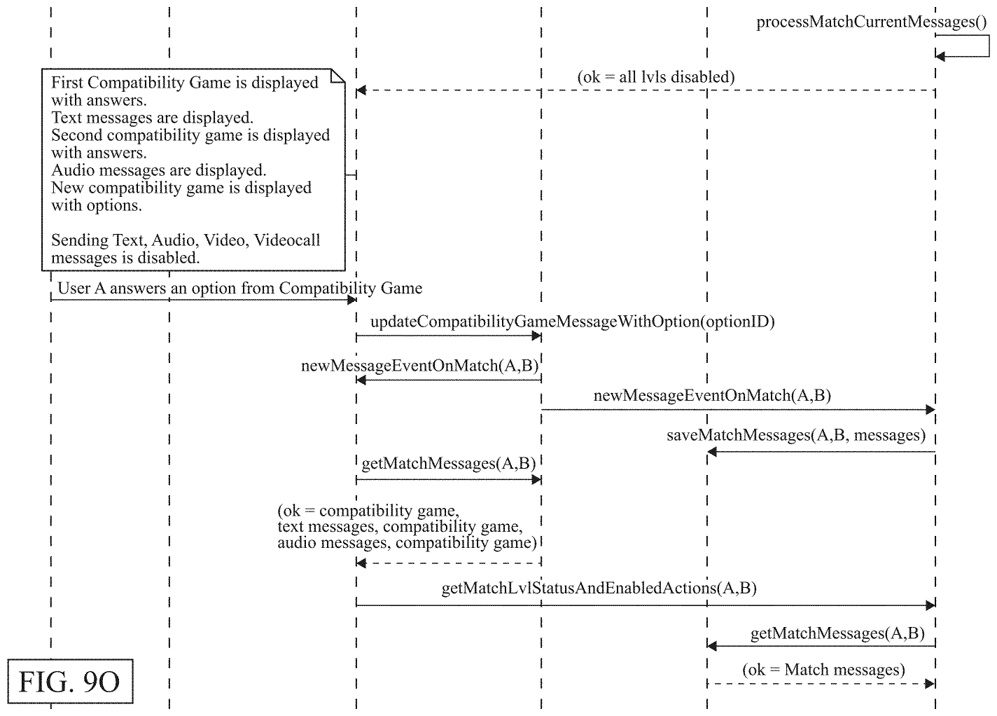

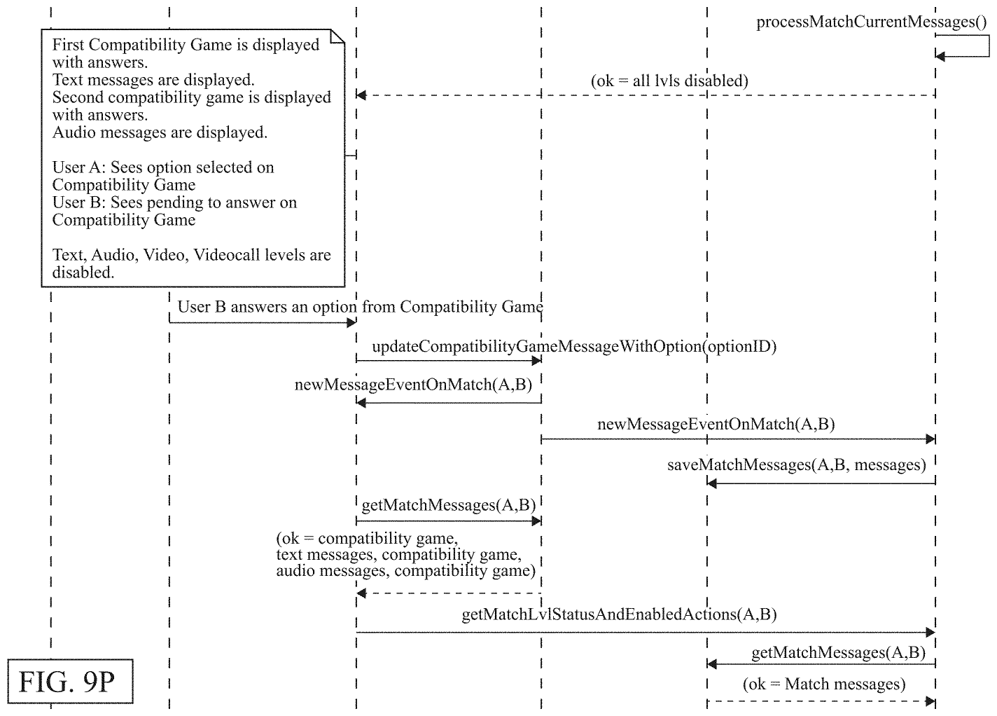

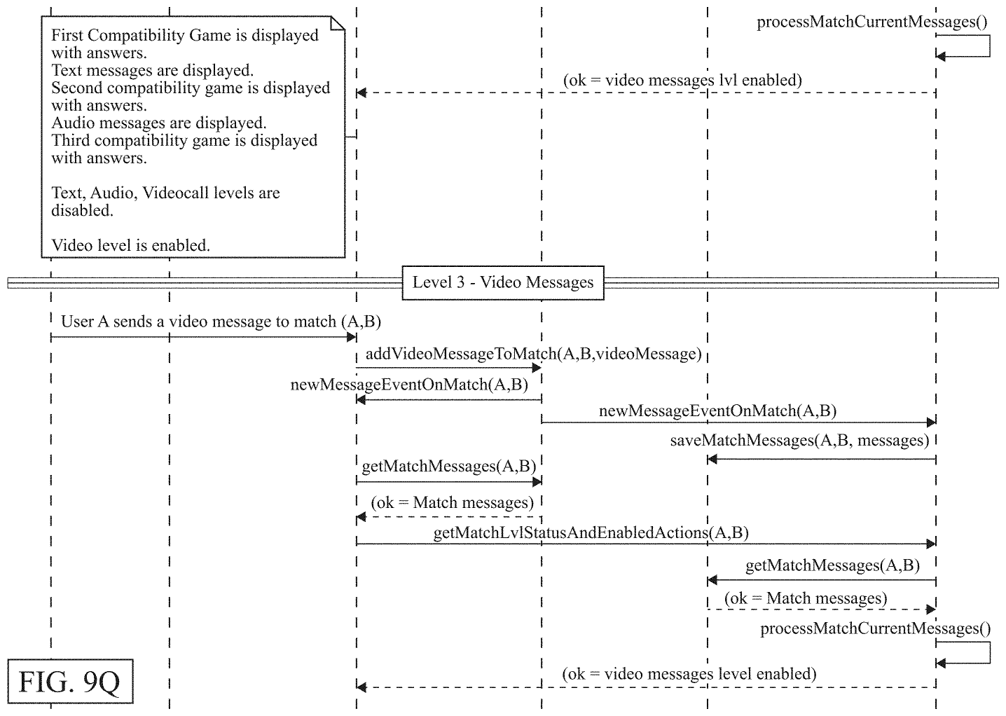

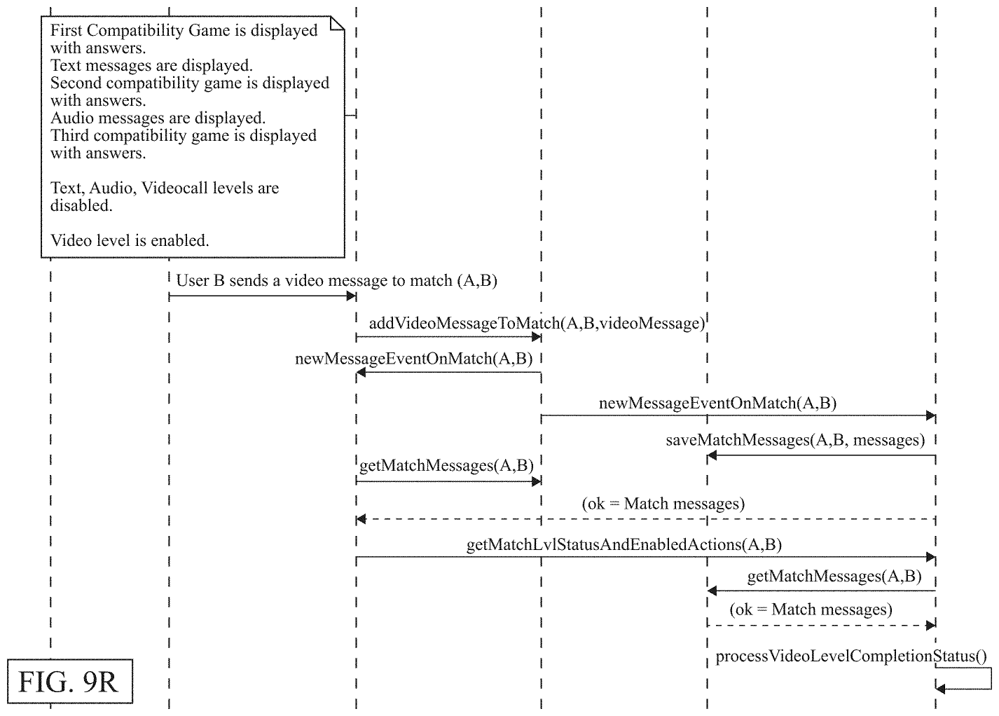

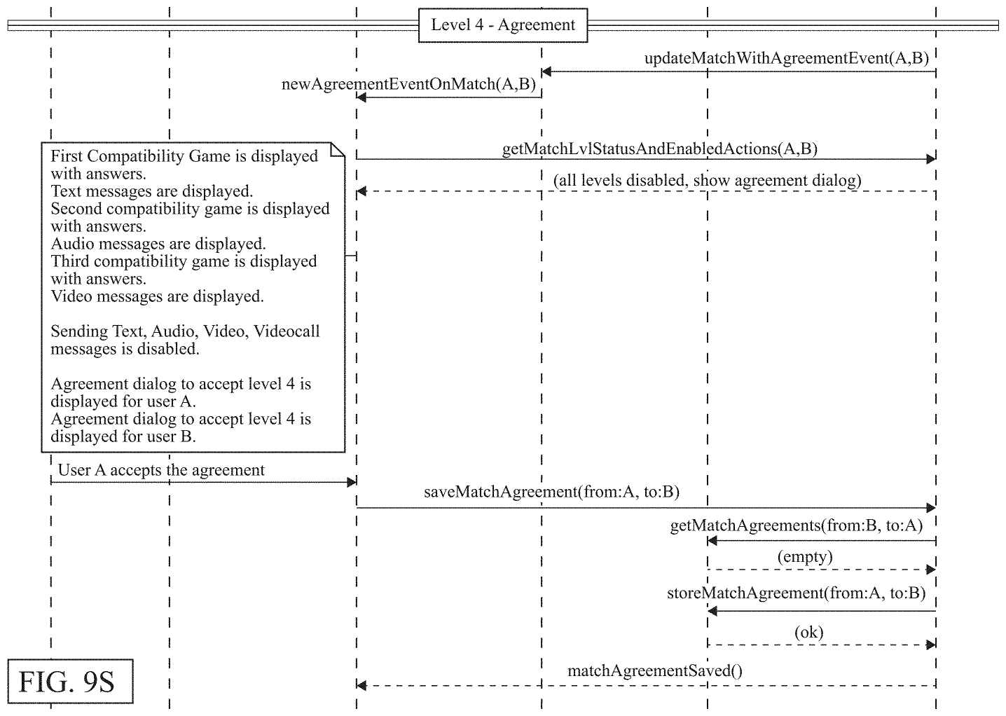

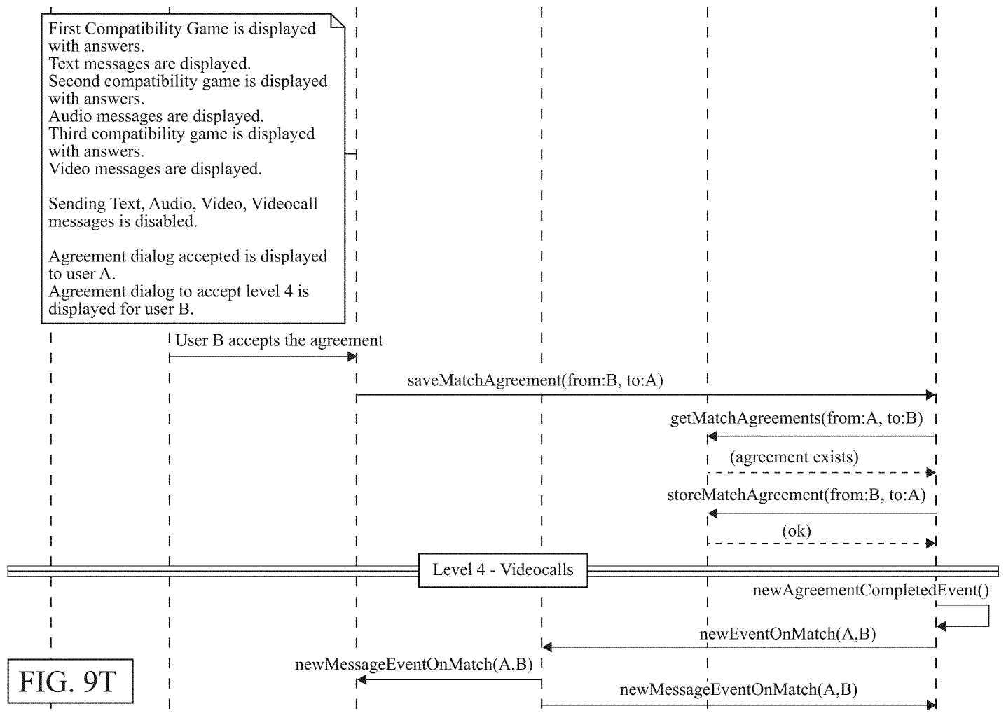

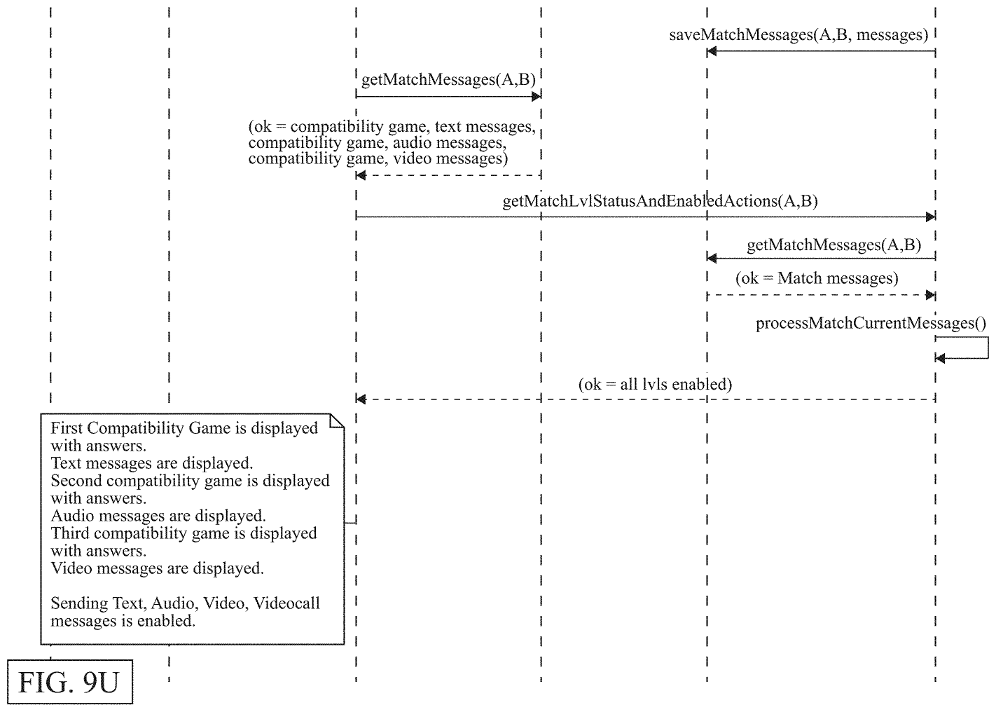

FIGS. 9-9U is a communication sequence diagram for the progressively deeper forms of communication between two previously unknown individuals in a predetermined time frame. The communication sequence diagram illustrates the communications between the two previously unknown individuals 6 and 7 (here user A and user b), the mobile app 20 on the mobile phones 15, the realtime database 71 and the database 70, and the back end server 40.

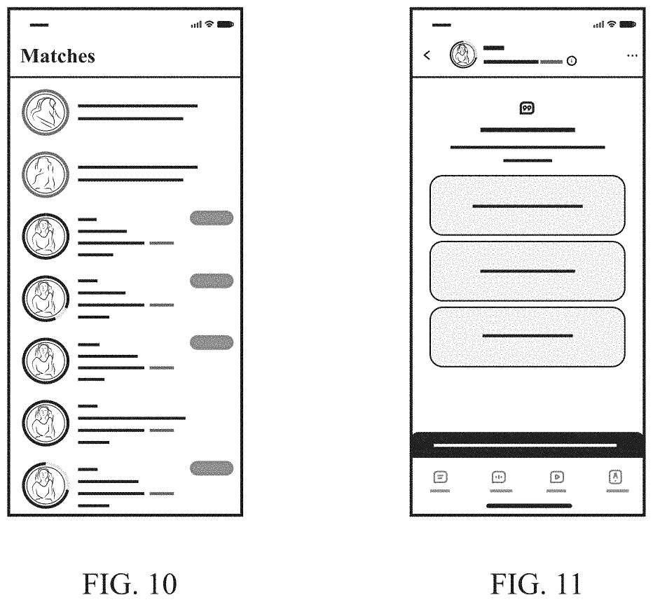

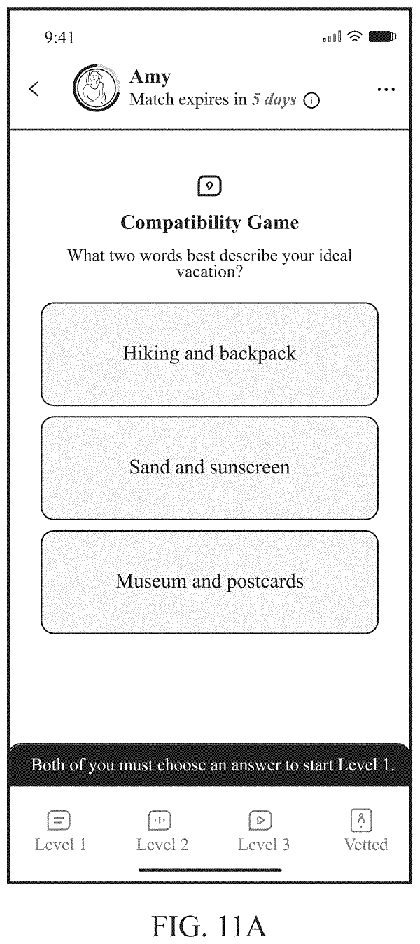

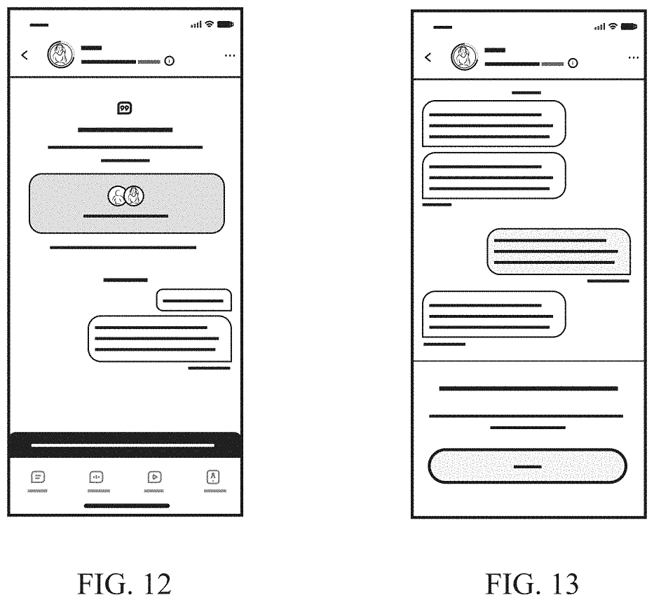

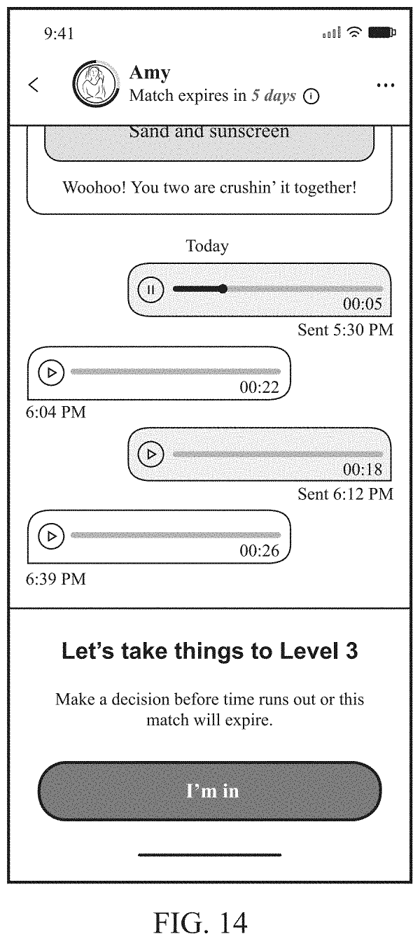

FIGS. 10-14 illustrate screenshots on the mobile app for the progressively deeper forms of communication between two previously unknown individuals in a predetermined time frame.

An operating system controls the execution of other computer programs, running of the PSO platform, and provides scheduling, input-output control, file and data management, memory management, and communication control and related services. The operating system may be, for example Windows (available from Microsoft, Corp. of Redmond, Wash.), LINUX or other UNIX variants (available from Red Hat of Raleigh, N.C. and various other vendors), Android and variants thereof (available from Google, Inc. of Mountain View, Calif.), Apple OS X, iOs and variants thereof (available from Apple, Inc. of Cupertino, Calif.), or the like.

The method described in connection with the embodiments disclosed herein is preferably embodied directly in hardware, in a software module executed by a processor, or in a combination of the two. A software module preferably resides in flash memory, ROM memory, EPROM memory, EEPROM memory, RAM memory, registers, a hard disk, a removable disk, a CD-ROM, or any other form of storage medium known in the art. An exemplary storage medium is preferably coupled to the processor, so that the processor reads information from, and writes information to, the storage medium. In the alternative, the storage medium is integral to the processor. In additional embodiments, the processor and the storage medium reside in an Application Specific Integrated Circuit (ASIC). In additional embodiments, the processor and the storage medium reside as discrete components in a computing device. In additional embodiments, the events and/or actions of a method reside as one or any combination or set of codes and/or instructions on a machine-readable medium and/or computer-readable medium, which are incorporated into a computer software program.

In additional embodiments, the functions described are implemented in hardware, software, firmware, or any combination thereof. If implemented in software, the functions are stored or transmitted as one or more instructions or code on a computer-readable medium. Computer-readable media includes both computer storage media and communication media including any medium that facilitates transfer of a computer program from one place to another. A storage medium is any available media that is accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection is termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and BLU-RAY disc where disks usually reproduce data magnetically, while discs usually reproduce data optically with lasers. Combinations of the above should also be included within the scope of computer-readable medium.

A computer program code for carrying out operations of the Present Invention is preferably written in an object oriented, scripted or unscripted programming language such as C++, C#, SQL, Java, Python, Javascript, Typescript, PHP, Ruby, or the like.

Each of the interface descriptions preferably discloses use of at least one communication protocol to establish handshaking or bi-directional communications. These protocols preferably include but are not limited to XML, HTTP, TCP/IP, Serial, UDP, FTP, Web Services, WAP, SMTP, SMPP, DTS, Stored Procedures, Import/Export, Global Positioning Triangulation, IM, SMS, MMS, GPRS and Flash. The databases used with the system preferably include but are not limited to MSSQL, Access, MySQL, Oracle, DB2, Open Source DBs and others. Operating system used with the system preferably include Microsoft 2010, XP, Vista, 200o Server, 2003 Server, 2008 Server, Windows Mobile, Linux, Android, Unix, I series, AS 400 and Apple OS.

The underlying protocol at a server, is preferably Internet Protocol Suite (Transfer Control Protocol/Internet Protocol (“TCP/IP”)), and the transmission protocol to receive a file is preferably a file transfer protocol (“FTP”), Hypertext Transfer Protocol (“HTTP”), Secure Hypertext Transfer Protocol (“HTTPS”), or other similar protocols. The protocol at the server is preferably HTTPS.

Components of a server includes a CPU component, a graphics component, memory, non-removable storage, removable storage, Network Interface, including one or more connections to a fixed network, and SQL database(s). Included in the memory, is an operating system, a SQL server or other database engine, and computer programs/software.

A mobile communication devices utilized with the present invention preferably include mobile phones, smartphones, tablet computers, PDAs and the like. Examples of smartphones include the IPHONE® smartphone from Apple, Inc., BLACKBERRY® smartphones from Research In Motion, the DROID® smartphone from Motorola Mobility Inc., GALAXY S® smartphones from Samsung Electronics Co., Ltd, and many more. Examples of tablet computing devices include the IPAD® tablet from Apple Inc., and the GALAXY TAB® tablet from Samsung Electronics Co., Ltd.

A typical mobile communication device includes an accelerometer, I/O (input/output), a microphone, a speaker, a GPS chipset, a Bluetooth component, a Wi-Fi component, a 3G/4G component, RAM memory, a main processor, an OS (operating system), applications/software, a Flash memory, SIM card, LCD display, a camera, a power management circuit, a battery or power source, a magnetometer, and a gyroscope.

A mobile communication service provider (aka phone carrier) of the customer such as VERIZON, AT&T, SPRINT, T-MOBILE, and the like mobile communication service providers, provide the communication network for communication to the mobile communication device of the end user.

Wireless standards include 802.11a, 802.11b, 802.11g, AX.25, 3G, CDPD, CDMA, GSM, GPRS, radio, microwave, laser, Bluetooth, 802.15, 802.16, and IrDA.

Components of a server includes a CPU component, a graphics component, PCI/PCI Express, memory, non-removable storage, removable storage, Network Interface, including one or more connections to a fixed network, and SQL database(s), which includes the venue's CRM. Included in the memory, is an operating system, a SQL server or other database engine, and computer programs/software. The server also includes at least one computer program configured to receive data uploads and store the data uploads in the SQL database. Alternatively, the SQL server can be installed in a separate server from the venue server.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes modification and substitutions of equivalents may be made therein without departing from the spirit and scope of this invention which is intended to be unlimited by the foregoing except as may appear in the following appended claim. Therefore, the embodiments of the invention in which an exclusive property or privilege is claimed are defined in the following appended claims.

I claim as my invention the following:

1. A method for progressively deeper forms of communication between two previously unknown individuals in a predetermined time frame, the method comprising:
generating a new message thread between two previously unknown individuals;
exchanging a plurality of text messages between the two previously unknown individuals;
agreeing between the two previously unknown individuals to proceed to a level two;
exchanging a plurality of voice messages between the two previously unknown individuals;
agreeing between the two previously unknown individuals to proceed to a level three;
exchanging a plurality of video messages between the two previously unknown individuals; and
agreeing between the two previously unknown individuals to proceed to a final level of exchanging phone numbers.

2. The method according to claim 1 further comprising playing a compatibility game before each of exchanging a plurality of text messages, exchanging a plurality of voice messages and exchanging a plurality of video messages.

3. The method according to claim 2 wherein the compatibility game is a multiple choice questions game.

4. The method according to claim 1 wherein the predetermined time frame is from three days to seven days.

5. The method according to claim 2 wherein the compatibility game is an open form answers game.

6. A server for progressively deeper forms of communication between two previously unknown individuals in a predetermined time frame, the server configured to:
process a new message thread between two previously unknown individuals;
enable the playing of a plurality of a compatibility games between the two previously unknown individuals;
enable the exchange of a plurality of text messages between the two previously unknown individuals;
enable the agreement between the two previously unknown individuals to proceed to higher levels of communications;
enable the exchange of a plurality of voice messages between the two previously unknown individuals;
enable the exchange of at least one video message between the two previously unknown individuals; and
enable the agreement between the two previously unknown individuals to proceed to a final level of exchanging phone numbers within seven days of the new message thread.

7. The server according to claim 6 further comprising playing a compatibility game before each of exchanging a plurality of text messages, exchanging a plurality of voice messages and exchanging a plurality of video messages.

8. The method according to claim 7 wherein the compatibility game is a multiple choice questions game.

9. The method according to claim 6 wherein the predetermined time frame is from three days to seven days.

10. The method according to claim 7 wherein the compatibility game is an open form answers game.

11. A method for progressively deeper forms of communication between two previously unknown individuals in a predetermined time frame, the method comprising:
requesting at a mobile application a state from a server including functionality enablement flags when the user signals intent to communicate with a match;
accepting at a sender's mobile application a message text and making an API call to the server;
storing at the server the message and notifying the recipient using both a realtime Pubnub message and using a mobile-native push notification;
providing a plurality of games containing specific business logic to assess mutual compatibility;
accepting at the sender's mobile application a voice message using a built-in microphone, wherein the voice message is transcoded to a normalized bitrate on the mobile application, and the transcoded voice message is transmitted to the server where the server stores the audio file on S3 and then notifies the recipient in the same way as for messages;
accepting at the sender's mobile application a video using a built-in video camera, wherein the video file is transcoded to a normalized bitrate on the mobile application, and the transcoded video file is transmitted to the server where the server stores the video file on S3 and then notifies the recipient in the same way as for messages; and
storing at the server the acceptance state of the other party and once accepted the server transmits the previously saved phone number to the other party.

12. The method according to claim 11 further comprising playing a compatibility game before each of exchanging a plurality of text messages, exchanging a plurality of voice messages and exchanging a plurality of video messages.

13. The method according to claim 12 wherein the compatibility game is a multiple choice questions game.

14. The method according to claim 11 wherein the predetermined time frame is from three days to seven days.

15. The method according to claim 12 wherein the compatibility game is an open form answers game.
